(19) United States
(12) Patent Application Publication
(10) Pub. No.: US 2005/0172177 A1
(43) Pub. Date: Aug. 4, 2005

(54) Semiconductor memory device for correcting errors using ECC (error correcting code) circuit

(76) Inventor: Kohei Oikawa, Kamakura-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/823,658

(22) Filed: Apr. 14, 2004

(30) Foreign Application Priority Data
Jan. 19, 2004 (JP) 2004-010806

(51) Int. Cl. G06F 11/00

(52) U.S. Cl. 714/52

(57) ABSTRACT

A semiconductor memory device includes a memory array having at least a first area and a second area, which stores cell data, a data input circuit located closer to the first area than the second area, to which the cell data is input, and an error correction circuit which generates parity data for error correction from the cell data input to the data input circuit. The device further includes a control circuit which stores the parity data in the first area.

### CROSS-REFERENCE TO RELATED APPLICATIONS

This application is based upon and claims the benefit of priority from prior Japanese Patent Application No. 2004-010806, filed Jan. 19, 2004, the entire contents of which are incorporated herein by reference.

### BACKGROUND OF THE INVENTION

1. Field of the Invention

The present invention relates to a semiconductor memory device. More specifically, the invention relates to a semiconductor memory device for correcting errors using an ECC (error correcting code) circuit.

2. Description of the Related Art

Conventionally a data correcting method using an ECC circuit has been widely known in the field of information transmission technology. Semiconductor memory devices have used an ECC circuit to improve in yield and reliability (see, for example, Jpn. Pat. Appln. KOKAI Publication No. 2003-151297). It is expected that semiconductor memory devices will be loaded with an ECC circuit more frequently to improve in yield and reliability.

However, semiconductor memory devices are likely to increase in data access time in memories as the memories increase in capacity and packing density. The use of an ECC circuit increases the data access time. The increase in data access time is a serious problem in the performance of semiconductor memory devices.

### BRIEF SUMMARY OF THE INVENTION

According to a first aspect of the present invention, there is provided a semiconductor memory device comprising a memory array including at least a first area and a second area, which stores cell data; a data input circuit located closer to the first area than the second area, to which the cell data is input; an error correction circuit which generates parity data for error correction from the cell data input to the data input circuit; and a control circuit which stores the parity data in the first area.

According to a second aspect of the present invention, there is provided a semiconductor memory device comprising a memory array including at least a first area and a second area; a data input circuit located closer to the first area than the second area, cell data to be stored in the memory array being input to the data input circuit; an error correction circuit which generates parity data for error correction from the cell data input to the data input circuit; and a control circuit which stores the parity data in the first area and store the cell data in the second area.

### BRIEF DESCRIPTION OF THE SEVERAL VIEWS OF THE DRAWING

FIG. 1 is a block diagram showing a basic configuration of a semiconductor memory device including an ECC circuit according to a first embodiment of the present invention.

FIG. 2 is a circuit diagram showing an arrangement of a first switching circuit of the semiconductor memory device shown in FIG. 1.

FIG. 3 is a circuit diagram showing an arrangement of a second switching circuit of the semiconductor memory device shown in FIG. 1.

FIG. 4 is a block diagram showing a basic configuration of a semiconductor memory device including an ECC circuit according to a second embodiment of the present invention.

FIG. 5 is a block diagram showing a basic configuration of a semiconductor memory device including an ECC circuit according to a third embodiment of the present invention.

### DETAILED DESCRIPTION OF THE INVENTION

Embodiments of the present invention will now be described with reference to the accompanying drawings.

### First Embodiment

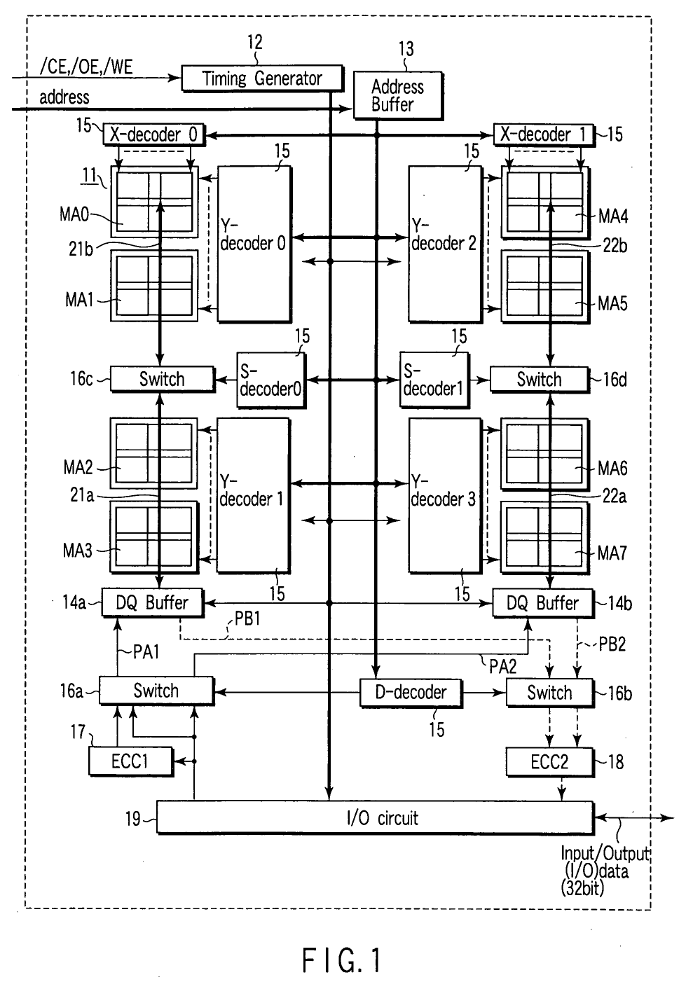

FIG. 1 shows a basic configuration of a semiconductor memory device including an ECC circuit according to a first embodiment of the present invention. In the first embodiment, 6-bit parity data is added to 32-bit input/output data (cell data) as a system of the ECC circuit. Further, 38-bit data, which is obtained by adding 6-bit parity data to 32-bit input/output data, is stored in different two memory areas by 19-bit data.

A semiconductor memory device according to the first embodiment comprises a memory array 11, a timing signal generator 12, an address buffer 13, DQ buffers 14a and 14b, a plurality of decoder circuits 15, switching circuits 16a, 16b, 16c and 16d, a parity generation circuit (ECC1) 17, an error correction circuit (ECC2) 18 and an input/output (I/O) circuit 19. Upon receiving external control signals /CE, /OE and /WE, the timing signal generator 12 controls the memory array 11, DQ buffers 14a and 14b and I/O circuit 19. Since the basic control of the timing signal generator 12 is known, its detailed descriptions are omitted.

The memory array 11 is divided into a plurality of (eight in the first embodiment) memory areas MA0, MA1, MA2, MA3, MA4, MA5, MA6 and MA7. These eight memory areas MA0 to MA7 are arranged in two lines four by four. The memory areas MA2, MA3, MA6 and MA7 make up a first area and the memory areas MA0, MA1, MA4 and MA5 make up a second area. The memory areas MA0, MA1, MA2 and MA3 make up a first memory unit and the memory areas MA4, MA5, MA6 and MA7 make up a second memory unit.

Of the memory areas MA0 to MA7, two memory areas are enabled nearly at the same time by one access. For example, the memory area MA0 of the second area and memory area MA6 of the first area, which widely differ in the distance from the I/O circuit 19, are enabled nearly at the same time. The memory area MA1 of the second area and memory area MA7 of the first area are enabled nearly at the same time. The memory area MA4 of the second area and memory area MA2 of the first area are enabled nearly at the same time. The memory area MA5 of the second area and memory area MA3 of the first area are enabled nearly at the same time.

The timing signal generator 12, parity generation circuit 17, error correction circuit 18 and switching circuit 16a are connected to the I/O circuit 19. The switching circuit 16a is connected to the decoder circuit (D-decoder) 15 and DQ buffers 14a and 14b. The error correction circuit 18 is connected to the DQ buffers 14a and 14b through the switching circuit 16b. The switching circuit 16b is connected to the decoder circuit (D-decoder) 15.

The timing signal generator 12 is connected to the DQ buffer 14a, and the memory areas MA2 and MA3 and switching circuit 16c are connected to the DQ buffer 14a through a 19-bit data line 21a. The memory areas MA0 and MA1 are connected to the switching circuit 16c through the 19-bit data line 21b. The timing signal generator 12 is connected to the DQ buffer 14b, and the memory areas MA6 and MA7 and switching circuit 16d are connected to the DQ buffer 14b through the 19-bit data line 22a. The memory areas MA4 and MA5 are connected to the switching circuit 16d through the 19-bit data line 22b.

The decoder circuits 15 are connected to the address buffer 13. The address buffer 13 receives an external address signal and supplies its corresponding internal address signal to each of the decoder circuits 15. The ratio of the value of the external address signal to that of the internal address signal is 1:1. The internal address signal uniquely defines the state of each of the decoder circuits 15 and switching circuits 16a to 16d.

For example, X-decoders 0 and 1, Y-decoders 0, 1, 2 and 3, S-decoders 0 and 1 and D-decoder are prepared as the decoder circuits 15. In response to the internal address signal, the X-decoders 0 and 1 and Y-decoders 0, 1, 2 and 3 select the memory areas MA0 to MA7 and cells in these memory areas. As described above, the memory array 11 is enabled by combinations of memory areas MA0 and MA6, memory areas MA1 and MA7, memory areas MA2 and MA4, and memory areas MA3 and MA5.

The S-decoders 0 and 1 control the switching circuits 16c and 16d, respectively. For example, when the memory areas MA0 and MA6 or memory areas MA1 and MA7 are selected, the switching circuit 16c turns on and the switching circuit 16d turns off. Conversely, when the memory areas MA2 and MA4 or memory areas MA3 and MA5 are selected, the switching circuit 16c turns off and the switching circuit 16d turns on.

The D-decoder controls the switching circuits 16a and 16b. In write mode, the switching circuit 16a distributes I/O data (13 bits) from the I/O circuit 19 and parity data (6 bits) from the parity generation circuit 17 to a data path PA1 connected to the DQ buffer 14a or a data path PA2 connected to the DQ buffer 14b. The switching circuit 16a distributes I/O data (19 bits) from the I/O circuit 19 to a path different from that of the parity data. In other words, when 19-bit data including parity data is distributed to the data path PA1, 19-bit data not including parity data is distributed to the data path PA2. Alternatively, when 19-bit data including parity data is distributed to the data path PA2, 19-bit data not including parity data is distributed to the data path PA1. The parity data generated from the parity generation circuit 17 is always distributed and stored in any one of the memory areas MA2, MA3, MA6 and MA7. In read mode, the switching circuit 16b switches a connection between the data paths PB1 and PB2 such that the order of data distributed to the DQ buffer 14a or 14b by 19 bits becomes equal to that of the original I/O data (32 bits).

It is assumed in the first embodiment that different data paths are used in read mode (PB1, PB2) and write mode (PA1, PA2) between the DQ buffers 14a and 14b and the I/O circuit 19. In read mode, data of 38 bits (19, 13+6) data is read out of each of enabled different memory areas. The read data is input to the error correction circuit 18 through the DQ buffers 14a and 14b and the data paths PB1 and PB2. Of 38-bit data, 32-bit I/O data that has been error-corrected using 6-bit parity data is supplied outside the device via the I/O circuit 19.

In write mode, the 32-bit I/O data input to the I/O circuit 19 is input to the switching circuit 16a and at the same time to the parity generation circuit 17. 6-bit parity data is thus generated from the parity generation circuit 17. The 6-bit parity data is sent to the switching circuit 16a. All the 38-bit data input to the switching-circuit 16a is divided into 19-bit data including 6-bit parity data and 19-bit data not including parity data, and these data are supplied to the DQ buffers 14a and 14b through the data paths PA1 and PA2, respectively. Hence, data of 38 bits (19, 13+6) is stored by 19 bits in different memory areas of different columns, which are enabled nearly at the same time.

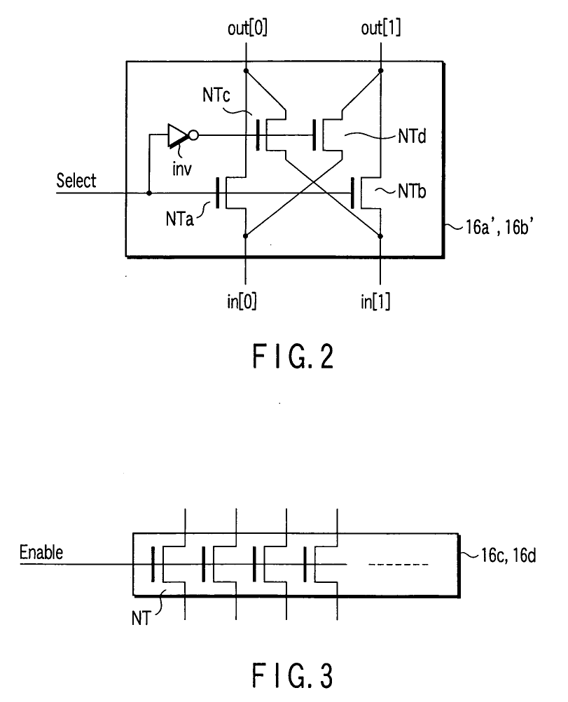

FIG. 2 shows an example of one of circuits 16a′ and 16b′ that form the above switching circuits 16a and 16b, respectively. Each of the circuits 16a′ and 16b′ is a 2-bit switch including four NMOS transistors NTa, NTb, NTc and NTd and one inverter circuit inv. In other words, the switching circuit 16a includes 19 circuits 16a′ and the switching circuit 16b includes 19 circuits 16b′.

In the circuits 16a′ and 16b′, when a select signal Select transmitted from the D-decoder is “1,” the NMOS transistors NTa and NTb turn on and the NMOS transistors NTc and NTd turn off. Thus, an input terminal in[0] and an output terminal out[0] are connected to each other, and so are an input terminal in[1] and an output terminal out[1]. Conversely, when the select signal Select is “0,” the NMOS transistors NTa and NTb turn off and the NMOS transistors NTc and NTd turn off. Thus, the input terminal in[0] and output terminal out[1] are connected to each other, and so are the input terminal in[1] and output terminal out[0].

In the switching circuit 16a, the output terminal out[0] corresponds to the data path PA1 and the output terminal out[1] corresponds to the data path A2. In the switching circuit 16b, the input terminal in[0] corresponds to the data path PB2 and the input terminal in[1] corresponds to the data path PB1.

FIG. 3 shows an example of an arrangement of each of the switching circuits 16c and 16d. The switching circuits 16c and 16d each include, for example, 19 NMOS transistors NT. The gates of the NMOS transistors are controlled in common by a single signal Enable from the S-decoders 0 and 1. In other words, when the signal Enable from the S-decoder 0 is not enabled, all the NMOS transistors NT of the switching circuit 16c turn off. Thus, the data lines 21a and 21b are electrically disconnected from each other. Similarly, when the signal Enable from the S-decoder 1 is not enabled, all the NMOS transistors NT of the switching circuit 16d turn off. Thus, the data lines 22a and 22b are electrically disconnected from each other.

There now follows an explanation as to an operation of the semiconductor memory device with the above configuration. Assume that different two memory areas MA0 and MA6 are enabled nearly at the same time by one access.

For example, in write mode, when 32-bit I/O data is input to the I/O circuit 19, it is sent to the switching circuit 16a and parity generation circuit 17. The parity generation circuit 17 generates 6-bit parity data based on the 32-bit data and sends it to the switching circuit 16a.

In the above case, the switching circuit 16c is connected in response to a signal Enable indicative of an enabled state from the S-decoder 0, and the switching circuit 16d is disconnected in response to a signal Enable indicative of a disenabled state from the S-decoder 1. When a select signal Select from the D-decoder is “0,” the input and output terminals in[0] and out[1] of the switching circuit 16a are connected to each other and so are the input and output terminals in[1] and out[0] thereof. Thus, the switching circuit 16a supplies an output signal (6-bit parity data) of the parity generation circuit 17 and part (13-bit I/O data) of an output signal of the I/O circuit 19 to the data path PA2 connected to the DQ buffer 14b. The switching circuit 16a also supplies the other part (19-bit I/O data) of the-output signal of the I/O circuit 19 to the data path PA1 connected to the DQ buffer 14a.

Of the 32-bit I/O data sent to the switching circuit 16a, 19-bit I/O data is sent to the DQ buffer 14a at once through the data path PA1. The DQ buffer 14a sends the I/O data to the memory area MA0 through the data line 21a, switching circuit 16c and data line 21b and stores it therein.

Of the 32-bit I/O data sent to the switching circuit 16a, 13-bit I/O data is sent to the DQ buffer 14b through the data path PA2 together with 6-bit parity data from the parity generation circuit 17. The DQ buffer 14b sends the I/O data to the memory area MA6 through the data line 22a and stores it therein.

In write mode, as described above, the original I/O data (32 bits) is not changed but stored as it is. Time required for writing data to the memory area MA0 is data write time (not including parity generation time). In contrast, time required for writing data to the memory area MA6 includes parity generation time; however, delay time of wire such as the data line 22a is shorter than when data is written to the memory area MA0. In other words, data write time depends upon a longer one of parity generation time and wire delay time. Data write time is therefore shorter than that of the prior art device in which parity generation time is included in time required for writing data to the memory area MA0.

In read mode, data of all bits is required for the processing of the error correction circuit 18. Time required for reading data therefore depends upon delay time of wire such as a data line and operation time for correcting errors. In other words, data read time is almost equal to that in the prior art device.

In the write and read modes described above, the switching circuits 16c and 16d selectively drive one of the data lines 21b and 22b. It is thus possible to reduce part of current consumed by the data lines (about ¼ the current consumption of the prior art device).

According to the foregoing semiconductor memory device with an ECC circuit, parity data is stored in the memory areas MA2, MA3, MA6 and MA7 that are located close to the I/O circuit 19 and data not to be processed is stored in the memory areas MA0, MA1, MA4 and MA5 which are located away from the circuit 19. In other words, the memory areas that are located close to and away from the I/O circuit are enabled nearly at the same time. Data requiring time for writing can be written to the memory areas close to the I/O circuit, while data not requiring time for writing can be written to the memory areas far from the I/O circuit. Time required for data access, especially data write can thus be shortened.

Moreover, the length of effective data lines can be controlled, or the data lines 21b and 22b can selectively be driven; consequently, power consumption can be decreased.

### Second Embodiment

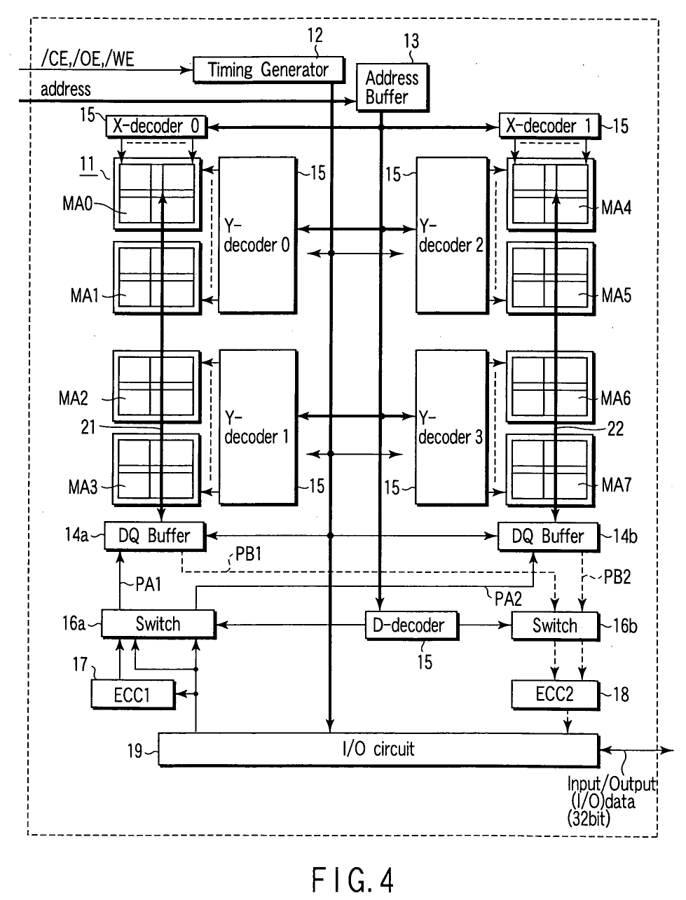

FIG. 4 shows a basic configuration of a semiconductor memory device including an ECC circuit according to a second embodiment of the present invention. The same components as those of the device shown in FIG. 1 are indicated by the same reference numerals and their detailed descriptions are omitted.

In the second embodiment, memory areas MA0, MA1, MA2 and MA3 of one column are connected in common by a single data line 21 and memory areas MA4, MA5, MA6 and MA7 of the other column are connected in common by a single data line 22. With this configuration, no advantage of reducing power consumption can be expected. However, the advantage of shortening time necessary for data access, especially data write can be obtained as in the first embodiment.

### Third Embodiment

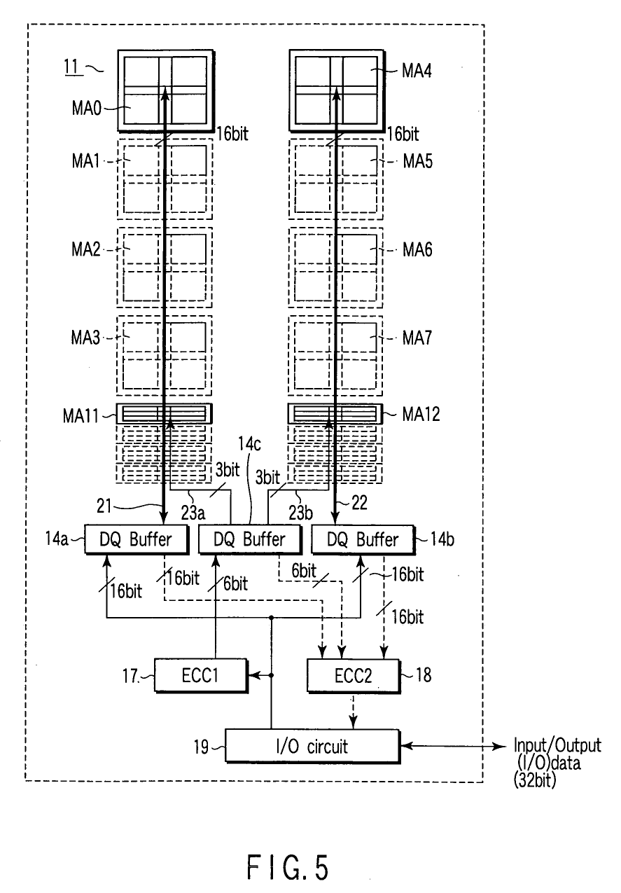

FIG. 5 shows a basic configuration of a semiconductor memory device including an ECC circuit according to a third embodiment of the present invention. For the sake of convenience, a timing signal generator, an address buffer and a decoder circuit are deleted from FIG. 5. The same components as those of the devices shown in FIGS. 1 and 4 are indicated by the same reference numerals and their detailed descriptions are omitted.

In the third embodiment, memory areas MA11 and MA12 exclusively for storing parity data are added to the memory areas MA0 to MA7. The memory areas MA11 and MA12 are located closer to the I/O circuit 19 than the memory areas MA0 to MA7. Data lines 23a and 23b connected to the memory areas MA11 and MA12 and a DQ buffer 14c are added to the data lines 21 and 22 connected to the memory areas MA0 to MA3 and memory areas MA4 to MA7. With this configuration, too, data access can be increased as in the first and second embodiments because the data lines 23a and 23b connected to the memory areas MA11 and MA12 for storing parity data are shorter than the other data lines 21 and 22.

In the first and second embodiments, the sizes of the memory areas are the same everywhere; however, they can be varied from place to place. For example, in the semiconductor memory device shown in FIG. 1, the size of each of the memory areas MA2, MA3, MA6 and MA7 can be made smaller than that of each of the memory areas MA0, MA1, MA4 and MA5. The memory areas MA2, MA3, MA6 and MA7 are used only for error correction and the memory areas MA0, MA1, MA4 and MA5 store I/O data other than parity data. This configuration allows parity data to be written at high speed and makes it possible to take time to generate parity data.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A semiconductor memory device comprising:
a memory array including at least a first area and a second area, which stores cell data;
a data input circuit located closer to the first area than the second area, to which the cell data is input;
an error correction circuit which generates parity data for error correction from the cell data input to the data input circuit; and
a control circuit which stores the parity data in the first area.

2. The semiconductor memory device according to claim 1, wherein the memory array includes a first memory unit and a second memory unit having the first area and the second area, respectively.

3. The semiconductor memory device according to claim 1, wherein the memory array includes a first data line connected to the first area and a second data line connected to the second area.

4. The semiconductor memory device according to claim 3, further comprising a switch between the first data line and the second data line.

5. The semiconductor memory device according to claim 1, wherein the memory array includes a common data line connected to both the first area and the second area.

6. A semiconductor memory device comprising:
a memory array including at least a first area and a second area;
a data input circuit located closer to the first area than the second area, cell data to be stored in the memory array being input to the data input circuit;
an error correction circuit which generates parity data for error correction from the cell data input to the data input circuit; and
a control circuit which stores the parity data in the first area and store the cell data in the second area.

7. The semiconductor memory device according to claim 6, wherein the control circuit stores both the parity data and the cell data in the first area and store the cell data not including the parity data in the second area.

8. The semiconductor memory device according to claim 6, wherein the memory array includes at least a first memory unit and a second memory unit each having the first area and the second area.

9. The semiconductor memory device according to claim 8, wherein the first memory unit has a first data line connected to the first area and a second data line connected to the second area, and the second memory unit has a first data line connected to the first area and a second data line connected to the second area.

10. The semiconductor memory device according to claim 9, wherein the first data line and the second data line are electrically connected to or disconnected from each other by a selection switch.

11. The semiconductor memory device according to claim 8, wherein the first memory unit and the second memory unit each have a common data line connected to both the first area and the second area.

12. The semiconductor memory device according to claim 1, wherein the memory array includes at least a first memory unit and a second memory unit each having the first area and the second area, and the semiconductor memory device further comprises a switching circuit which stores the parity data in the first area of one of the first memory unit and the second memory unit.

13. The semiconductor memory device according to claim 1, further comprising a data compensating circuit which error-corrects the cell data stored in the memory array using the parity data stored in the first area.

14. The semiconductor memory device according to claim 1, wherein a size of the first area is equal to or smaller than that of the second area.

15. The semiconductor memory device according to claim 6, wherein the memory array includes at least a first memory unit and a second memory unit each having the first area and the second area, and the semiconductor memory device further comprises a switching circuit which stores the parity data in the first area of one of the first memory unit and the second memory unit.

16. The semiconductor memory device according to claim 6, further comprising a data compensating circuit which error-corrects the cell data stored in the memory array using the parity data stored in the first area.

17. The semiconductor memory device according to claim 6, wherein a size of the first area is equal to or smaller than that of the second area.
